(19) United States
(12) Patent Application Publication
(10) Pub. No.: US 2022/0073417 A1
(43) Pub. Date: Mar. 10, 2022

(54) TRANSPARENT SOLID SPHERES AND METHOD FOR PRODUCING SAME

(71) Applicant: 3M INNOVATIVE PROPERTIES COMPANY, St. Paul, MN (US)

(72) Inventors: Toshihiro Kasai, Kanagawa (JP); Kenton D. Budd, Woodbury, MN (US); Jean A. Tangeman, Minneapolis, MN (US); Billy J. Frederick, Jr., Woodbury, MN (US)

(21) Appl. No.: 17/309,854

(22) PCT Filed: Dec. 20, 2019
(86) PCT No.: PCT/IB2019/061231

§ 371 Date: Jun. 24, 2021

(30) Foreign Application Priority Data
Dec. 26, 2018 (JP) 2018-243401

(51) Int. Cl. C03C 12/02; C03C 3/12; C03B 19/10

(52) U.S. Cl. CPC C03C 12/02; C03B 19/102; C03C 3/127

(57) ABSTRACT

To provide transparent solid spheres with high refractive index and large particle size. The transparent solid spheres of one aspect of the present disclosure include barium oxide, zirconium dioxide, and titanium dioxide on a theoretical oxide basis, and has a refractive index of at least 2.0 and a particle size of 600 micrometers or greater.

### TECHNICAL FIELD

The present invention relates to transparent solid spheres and a method for producing the same.

### BACKGROUND

For example, transparent glass beads have retroreflectivity, and thus are used in markers of road signs on pavements.

Patent Document 1 (JP 2988831 B) describes high refractive index glass beads that include TiO₂ and BaO and have a refractive index increased by heat treatment, in which the Fe₂O₃ content in the glass beads is from 0.005 to 0.1% by mass, and the particle diameter of the high refractive index crystals in the glass beads is 0.3 micrometers or less.

Patent Document 2 (JP 2001-342039 A) describes spherical glass beads for retroreflection, the glass beads having an average particle size of 100 micrometers or less and a refractive index of 1.8 to 2.6, in which fine particles are adhered to the surface of the glass beads to make the angle of repose 22° or less.

Patent Document 3 (JP 2003-505328 T) describes transparent solid microspheres including titania and at least one type of alumina, zirconia, and silica, in which the total content percentage of titania and alumina, zirconia and/or silica is at least about 75 wt % relative to the total weight of the solid microspheres, and the total content percentage of titania, alumina, and zirconia is greater than the content of silica, the content percentage of titania is from about 10 wt % to about 50 wt % relative to the total weight of the solid microspheres, and the size of the solid spheres is from about 50 to about 500 micrometers.

### SUMMARY

For example, when a marker of a road sign using retroreflective transparent beads is wet in the rain and the difference in the refractive index between rainwater and the transparent beads is relatively small, the reflected light is difficult to see. Therefore, in order to improve the visibility of the reflected light in the rain, the increase of the refractive index of the transparent beads themselves for increasing the difference in the refractive index between rainwater and the transparent beads has been desired.

When transparent beads are applied to a marker of a road sign, for example, the transparent beads are scattered over the marker with which a pavement is coated, in an undried state. However, if the particle size of the transparent beads is small, the beads can be easily buried in the marker, and therefore a large amount of transparent beads need to be scattered. Transparent beads having a small particle size have a small contact area with the surface of the marker, and therefore there is another problem that the transparent beads can be easily dropped from the marker by friction with tires. Therefore, transparent beads with a large particle size were desired, but in a prior art producing method using a flame, transparent beads with a high refractive index and a small particle size are obtained, but it is difficult to obtain transparent beads with a high refractive index and a large particle size.

An object of the present disclosure is to provide transparent solid spheres having a high refractive index and a large particle size.

According to one aspect of the present disclosure, provided are transparent solid spheres including barium oxide, zirconium dioxide, and titanium dioxide on a theoretical oxide basis, and having a refractive index of at least 2.0 and a particle size of 600 micrometers or greater.

According to another aspect of the present disclosure, provided is a method for producing transparent solid spheres, including the steps of: preparing a melt including (a) at least one of barium oxide and barium carbonate, (b) zirconium dioxide, (c) titanium dioxide, and optionally aluminum oxide on a theoretical oxide basis; releasing a discharge stream of at least a portion of the melt through holes, and injecting a gas stream to the discharge stream to obtain spheres; and cooling the spheres to form transparent solid spheres.

According to the present disclosure, transparent solid spheres having a high refractive index and a large particle size is provided.

The above descriptions should not be construed as that all aspects of the present disclosure and all advantages of the present disclosure are disclosed.

### DETAILED DESCRIPTION

Transparent solid spheres in one aspect of the present disclosure include barium oxide, zirconium dioxide, and titanium dioxide on a theoretical oxide basis, and have a refractive index of at least 2.00 and a particle size of 600 micrometers or greater. The transparent solid spheres of the present disclosure are transparent and have a refractive index of at least 2.00, and can sufficiently increase the difference in refractive index from that of water, and therefore, for example, further improve the visibility (retroreflectivity) of reflected light from transparent solid spheres wet in the rain in comparison with beads having a refractive index of less than 2.00. In addition, because the transparent solid spheres have a particle size of 600 micrometers or more, for example, the contact area with the marker surface can be increased, and therefore complete burying of the transparent solid spheres into the marker and dropping from the marker surface can be reduced or prevented.

The weight ratio of barium oxide included in the transparent solid spheres in some embodiments of the present disclosure is, for example, in the range from 35.0 to 47.0% on a theoretical oxide basis, relative to the total weight of the transparent solid spheres, and the weight ratio of zirconium dioxide is from 2.0 to 11.5% on a theoretical oxide basis, relative to the total weight of the transparent solid spheres. In some embodiments, the transparent solid spheres including barium oxide and zirconium dioxide at the above ratios can further improve transparency, retroreflectivity, and refractive index.

The weight ratio of titanium dioxide included in the transparent solid spheres in some embodiments of the present disclosure is in the range of, for example, from 37.0 to 54.0% on a theoretical oxide basis, relative to the total weight of the transparent solid spheres. In some embodiments, the transparent solid spheres including titanium dioxide at this ratio can further improve transparency, retroreflectivity, and refractive index.

The transparent solid spheres in some embodiments of the present disclosure may further include aluminum oxide. The inclusion of aluminum oxide improves the formability of the transparent solid spheres.

The weight ratio of aluminum oxide included in the transparent solid spheres in some embodiments of the present disclosure is in the range of, for example, from 1.5 to 11.0% on a theoretical oxide basis relative to the total weight of the transparent solid spheres. The inclusion of aluminum oxide included at this ratio further improves the formability of the transparent solid spheres.

The particle size of the transparent solid spheres in some embodiments of the present disclosure is, for example, 850 micrometers or greater. Transparent solid spheres having such particle sizes can, for example, further reduce or prevent complete burying and dropping of transparent solid spheres into and from a marker.

The particle size of the transparent solid spheres in some embodiments of the present disclosure is, for example, 1.0 millimeters or greater. The transparent solid spheres having this particle size can, for example, further reduce or prevent complete burying and dropping of the transparent solid spheres into and from a marker.

The refractive index of the transparent solid spheres in some embodiments of the present disclosure is, for example, 2.10 or greater. The transparent solid spheres having such a refractive index can further improve the visibility of the reflected light from the transparent solid spheres in a wet state.

The transparent solid spheres in some embodiments of the present disclosure have a crushing strength of, for example, 150 MPa or greater. Transparent solid spheres having such a crushing strength can, for example, further reduce or prevent crushing by tires of vehicles traveling on a road.

In transparent solid spheres in some embodiments of the present disclosure, the weight ratio of silicon dioxide is, for example, 5.0% or less relative to the total weight of the transparent solid spheres. When the ratio of silicon dioxide in the transparent solid spheres is within this range, transparency, retroreflectivity, and refractive index are further improved.

A retroreflective article in one aspect of the present disclosure includes at least one (typically a plurality) of disclosed transparent solid spheres. The transparent solid spheres of the present disclosure are relatively excellent in transparency, retroreflectivity, and refractive index, and thus are suitable for use in retroreflective articles.

A pavement marker in one aspect of the disclosure includes at least one (typically a plurality) of disclosed transparent solid spheres. The transparent solid spheres of the present disclosure are relatively excellent in transparency, retroreflectivity, and refractive index, and have a particle size of 600 micrometers or more, and thus are suitable for use in pavement markers.

A method for producing the transparent solid spheres in some embodiments of the present disclosure includes the steps of: preparing a melt including (a) at least one of barium oxide and barium carbonate, (b) zirconium dioxide, (c) titanium dioxide, and optionally aluminum oxide on a theoretical oxide basis; and releasing a discharge stream of at least a portion of the melt through a hole, and injecting a gas stream to the discharge stream to obtain spheres; and cooling the spheres to form transparent solid spheres. According to the producing method, transparent solid spheres having excellent transparency, a high refractive index, and a large particle diameter can be obtained.

Hereinafter, a more detailed description is given for the purpose of illustrating representative aspects of the present disclosure, but the present disclosure is not limited to these embodiments.

In the present disclosure, “transparent” may mean a state in which solid spheres are not cloudy, and may include colorless transparent or colored transparent. Specifically, in the retroreflectivity test described later, an object exhibiting a value of 3.0 (Cd/m²)/lux or greater, 3.5 (Cd/m²)/lux or greater, or 4.0 (Cd/m²)/lux or greater in a dry state can be defined as transparent. Because transparency and retroreflectivity are correlated, solid spheres exhibiting retroreflectivity in these ranges can be defined as transparent.

In the present disclosure, “solid” may mean a state free of substantial cavities and voids. Here, the term “substantial cavities and voids” means cavities and voids that make a product defective. Thus, the “solid spheres” of the present disclosure may have cavities and voids in very small amounts or with very small particle sizes that do not adversely affect optical quality (e.g., the range in which the solid spheres are transparent and exhibit a refractive index of at least 2.00). Specifically, the ratio of the cavities and voids in the solid spheres is 20 vol % or less, 10 vol % or less, or 5 vol % or less.

In the present disclosure, “sphere” may mean that the object is a substantially spherical body. Herein, a “substantially spherical body” may mean a spherical body that can be a good product. Specifically, the ratio (sphericity) of the longest diameter to the shortest diameter of a transparent solid sphere is 1.0 or greater or 1.2 or greater, and 2.0 or less or 1.5 or less.

The transparent solid spheres will be further described below.

The transparent solid spheres of the present disclosure have a refractive index of at least 2.00. For example, from the perspective of the visibility of the reflected light in the rain, the refractive index of the transparent solid spheres of some embodiments is, for example, 2.05 or greater or 2.10 or greater. The refractive index of the transparent solid spheres of some embodiments is, for example, 2.20 or less, 2.19 or less, or 2.18 or less.

The refractive index of the transparent solid spheres is measured based on, for example, “Refractive Index Measurement of High Refractive Index Beads”, T. Yamaguchi, Applied Optics, vol. 14, No. 5, p. 1111 to 1115 (1975). The disclosure of these documents is incorporated herein by reference.

The transparent solid spheres of the present disclosure have a particle size of 600 micrometers or greater. For example, the particle size of the transparent solid spheres of some embodiments is, for example, 700 micrometers or greater, 850 micrometers or greater, or 1.0 millimeters or greater from the perspective of burial resistance and drop-off resistance to the marker. The particle size of the transparent solid spheres of some embodiments is, for example, 2.0 millimeters or less, 1.7 millimeters or less, 1.5 millimeters or less, or 1.2 millimeters or less.

The particle size of the transparent solid spheres is defined using a sieve with a specific opening (SUS sieve, available from Sampoh Co., Ltd.). For example, a sieve with an opening in the range of 600 to 850 micrometers is used for transparent solid spheres in the range of 600 to 850 micrometers. The particle size of the transparent solid spheres remaining on the sieve without passing through it is defined to be 600 micrometers or more. Alternatively, the particle size of the transparent solid spheres can be determined by observation using an optical microscope. In this case, the particle size is defined as the average of the smallest diameter often or more transparent solid spheres.

The transparent solid spheres of the present disclosure have excellent transparency. The transparency of the transparent solid spheres can be defined by, for example, the retroreflectivity test described below. Specifically, in the retroreflectivity test, those exhibiting a value of 3.0 (Cd/m²)/lux or greater, 3.5 (Cd/m²)/lux or greater, or 4.0 (Cd/m²)/lux or greater in a dry state can be defined as transparent. The upper limit value is not particularly limited, but can be defined as, for example, 20.0 (Cd/m²)/lux or less, or 19.0 (Cd/m²)/lux or less.

The retroreflectivity of the transparent solid spheres of some embodiments in a wet state is, for example, 3.0 (Cd/m²)/lux or greater, 3.5 (Cd/m²) or greater, or 4.0 (Cd/m²)/lux or greater. The retroreflectivity in a wet state of the transparent solid spheres of some embodiments is, for example, 8.0 (Cd/m²)/lux or less, 7.5 (Cd/m²)/lux or less, or 7.0 (Cd/m²)/lux or less.

The transparent solid spheres of some embodiments have a crushing strength of, for example, 100 MPa or greater, 120 MPa or greater, or 150 MPa or greater. The crushing strength of the transparent solid spheres of some embodiments is, for example, 500 MPa or less.

The crushing strength of transparent solid spheres is determined in accordance with the test procedure described in U.S. Pat. No. 4,772,511 (Wood). One transparent solid sphere is placed on a sapphire plate, and a load is gradually applied from the top of the sapphire plate, and the crushing strength is derived from the load at the point when the transparent solid sphere is broken.

As is common in glass and ceramic technologies, the components of the transparent solid spheres of the present disclosure are in the form that includes oxides in the finished product, and can be expressed as oxides in the form that accurately describes the chemical elements and the proportions of chemical elements in the transparent solid spheres. The starting material used to produce the transparent solid spheres may be any compound such as a carbonate other than oxides, but the composition that constitutes the transparent solid spheres will be modified to the form of an oxide during melting of the raw material. For example, when barium carbonate is used as a starting material, the barium carbonate turns to barium oxide via a melting process. Thus, the composition of the transparent solid spheres of the present disclosure can be discussed from the perspective of theoretical oxide basis.

The transparent solid spheres of the present disclosure include at least three components, barium oxide (may be represented simply as “BaO”), zirconium dioxide (may be represented simply as “ZrO₂”), and titanium dioxide (may be represented simply as “TiO₂”).

The content of barium oxide in the transparent solid spheres is not particularly limited. For example, the weight ratio of barium oxide may be, for example, 35.0% or greater, 35.5% or greater, or 36.0% or greater, and may be 47.0% or less, 46.5% or less, or 46.0% or less on a theoretical oxide basis relative to the total weight of the transparent solid spheres.

The content of zirconium dioxide in the transparent solid spheres is not particularly limited. For example, the weight ratio of zirconium dioxide may be 2.0% or greater, 3.0% or greater, or 4.0% or greater, and may be 11.5% or less, 11% or less, 10.5% or less, or 10.0% or less on a theoretical oxide basis relative to the total weight of the transparent solid spheres.

The content of titanium dioxide in the transparent solid spheres is not particularly limited. For example, the weight ratio of titanium dioxide may be 37.0% or greater, 38.0% or greater, or 39.0% or greater, and may be 54.0% or less, 53.0% or less, or 52.0% or less on a theoretical oxide basis relative to the total weight of the transparent solid spheres.

The transparent solid spheres of some embodiments may further include aluminum oxide (may be represented simply as “Al₂O₃). In some embodiments, the inclusion of aluminum oxide improves the formability of the transparent solid spheres.

The content of aluminum oxide in the transparent solid spheres is not particularly limited. For example, the weight ratio of aluminum oxide may be, for example, 1.5% or greater, 1.8% or greater, or 2.0% or greater, and may be 11.0% or less, 10.5% or less, or 10.0% or less on a theoretical oxide basis, relative to the total weight of the transparent solid spheres.

When the transparent solid spheres further include aluminum oxide, i.e., when the transparent solid spheres include at least four components, the contents of barium oxide, zirconium dioxide, and titanium dioxide may be set to the following ranges.

In some embodiments, from the perspective of transparency and retroreflectivity (especially retroreflectivity in a wet state), the weight ratio of barium oxide is, for example, 36.0% or greater, 36.5% or greater, or 37.0% or greater, and 46.0% or less, 45.0% or less, 44.0% or less, 43.0% or less, 42.0% or less, 40.0% or less, or 39.0% or less on a theoretical oxide basis relative to the total weight of the transparent solid spheres.

In some embodiments, from the perspective of transparency and retroreflectivity (especially retroreflectivity in a wet state), the weight ratio of zirconium dioxide is, for example, preferably 3.5% or greater, 5.0% or greater, 7.0% or greater, or 9.0% or greater, and is preferably 11.5% or less, 11.0% or less, 10.5% or less, or 10.0% or less on a theoretical oxide basis relative to the total weight of the transparent solid spheres.

In some embodiments, from the perspective of transparency and retroreflectivity (especially retroreflectivity in a wet state), the weight ratio of titanium dioxide is, for example, preferably 38.0% or greater, 40% or greater, 42.0% or greater, or 45.0% or greater, and is preferably 52.0% or less, 51.5% or less, 51.0% or less, 50.5% or less, 50.0% or less, or 49.0% or less on a theoretical oxide basis relative to the total weight of the transparent solid spheres.

The transparent solid spheres of some embodiments may include any other component within the ranges that do not adversely affect the effects of the present disclosure.

When the transparent solid spheres are used in, for example, a white marker, the spheres are preferably colorless and transparent, but when used in, for example, a colored marker, the spheres are preferably colored and transparent in conformance with the color. Thus, the transparent solid spheres of some embodiments may include a colorant. Examples of the colorant include CeO₂, Fe₂O₃, CoO, Cr₂O₃, NiO, CuO, or MnO₂ on a theoretical oxide basis. Rare earth elements such as europium may also be included for fluorescence.

The transparent solid spheres of some embodiments may include silicon dioxide included in common glass beads at a weight ratio of, for example, 5.0% or less, 3.0% or less, or 1.0% or less on a theoretical oxide basis relative to the total weight of the transparent solid spheres. However, from the perspective of refractive index and formability, silicon dioxide is preferably not included.

The transparent solid spheres of some embodiments may include at least one type of yttrium, rare earth (rare earth elements such as lanthanum or samarium), or their oxides at a weight ratio of, for example, 1.0% or less, 0.1% or less, or 0.01% or less on a theoretical oxide basis relative to the total weight of the transparent solid spheres. However, from the perspective of cost, rare earth and its oxides are preferably not included.

Transparent solid spheres such as glass beads are generally prepared by the following method. Firstly, a burner flame is emitted in a horizontal direction, and raw material particles to be transparent solid spheres are dropped from above to the flame. The dropped raw material particles are blown off while being melted by the flame, and as they become separated from the flame, they are cooled in the air and become transparent solid spheres. However, when transparent solid spheres having a high refractive index are obtained by such a prior art method, only transparent solid spheres with a relatively small particle size of approximately 100 micrometers can be obtained because the raw material particles need to be melted within the range of the length of the flame.

According to Newton's law of cooling, it is known that the cooling rate dramatically decreases as the diameter of the transparent solid sphere increases. In addition, the transparency of the transparent solid spheres is determined by the relationship between the cooling rate and the crystallization rate, and it is generally known that the cooling rate becomes transparent when the cooling rate is greater than the crystallization rate. However, quenching of molten particles is difficult with the prior art method, which is one of the causes of difficulty in obtaining transparent solid spheres with a large refractive index and a large particle size.

Unlike the prior art producing method, the method for producing transparent solid spheres of the present disclosure uses no burner flame. The transparent solid spheres of the present disclosure can be prepared by a producing method including at least the following steps (1) to (3):

(1) preparing a melt including (a) at least one of barium oxide and barium carbonate, (b) titanium dioxide, (c) zirconium dioxide, and optionally aluminum oxide on a theoretical oxide basis;

(2) releasing a discharge stream of at least a portion of the melt through a hole, and injecting a gas stream to the discharge stream to obtain spheres; and

(3) cooling the spheres to form transparent solid spheres.

Unlike the known method, the method for producing transparent solid spheres according to the present disclosure does not use the raw material particles of transparent solid spheres, but uses a discharge stream of a melt of the raw material of transparent solid spheres, and thus is not subjected to the limitation by the size of the raw material particles. Therefore, transparent solid spheres with a higher refractive index and a larger particle size are produced compared to the prior art producing method.

Firstly, a melt to be the raw material of transparent solid spheres is prepared. At this time, the components of the raw material may be various types of oxides constituting the composition of the transparent solid spheres, or may be compounds such as carbonates that turn to various oxides by heat during melting. For example, barium carbonate that turns to barium oxide by heat during melting may be used as a raw material in the mixed material.

The melt may be prepared, for example, using a crucible. The crucible may be any crucible as long as it is resistant to the melting temperature of the mixed material, and the components of the crucible are not molten and included in the melt. For example, a crucible made of platinum (heat resistant temperature: about 1800° C.) or a crucible made of iridium (heat resistant temperature: about 2500° C.) may be used.

The bottom of the crucible used in the method for producing transparent solid spheres of some embodiments has one or more holes (outlet holes) for discharging the melt. The hole diameter may be appropriately selected so as to obtain, for example, transparent solid spheres having a desired particle size. The hole diameter is, for example, 0.5 millimeters or greater, 1.0 millimeters or greater, or 1.5 millimeters or greater, and 5.0 millimeters or less, 4.0 millimeters or less, or 3.0 millimeters or less.

The discharge stream is discharged through the hole in a direction substantially perpendicular to the ground. The discharge of the melt may be performed intermittently or continuously, but is preferably continuously performed from the perspective of, for example, productivity. Here, “substantially” in the present disclosure means that variations occurring during production can be included, and may mean, for example, that a variation within ±20% is allowed.

The gas component of the gas stream injected to the discharge stream is not particularly limited. For example, a gas stream of air, noble gas (e.g., argon gas), nitrogen, or a mixed gas thereof may be used. Among these, air is preferably used from the perspective of productivity.

The gas stream injection may be performed intermittently or continuously, and may be performed at one or more positions to the discharge stream.

The position at which the gas stream is applied is not particularly limited. The position of application of the gas stream is, for example, the position that is separated from the center of the outlet hole of the crucible in a direction perpendicular to the ground at a distance of, for example, 40 cm or greater, 45 cm or greater, or 50 cm or greater, and 150 cm at the maximum, 120 cm at the maximum, or 100 cm at the maximum. When the gas stream is applied from this position, transparent solid spheres having a large particle size are more easily obtained.

The angle of injection of the gas stream (the angle formed with the discharge stream) is not particularly limited. The injection angle of the gas stream is, for example, 60 degrees or greater, 70 degrees or greater, 80 degrees or greater, or 90 degrees or greater, and 120 degrees or less, 110 degrees or less, or 100 degrees or less relative to a perpendicular line extending from the center of the outlet hole of the crucible to the ground. The upstream side (outlet hole side) of the perpendicular line may be defined as 0 degree, and the downstream side (the ground side) of the perpendicular line may be defined as 180 degrees.

The spheres (molten drops) that have been repelled by the gas stream are cooled while flying in the air, and form transparent solid spheres. The longer the flying time in the air, the higher the cooling effect and the greater the transparency, the injection angle of the gas stream is preferably from 70 to 120 degrees, and more preferably from 90 to 120 degrees.

The temperature of the gas stream is also not particularly limited. The temperature of the gas stream is, for example, 40° C. or lower, 30° C. or lower, or 20° C. or lower, and 0° C. or higher, 5° C. or higher, or 10° C. or higher. When a gas stream in this temperature range is used, transparent solid spheres having excellent transparency are obtained. A gas stream at room temperature is used in the present embodiment, but a heated or cooled gas stream may be used.

The injection pressure of the gas stream is also not particularly limited. The injection pressure of the gas stream is, for example, 0.01 MPa or greater, 0.03 MPa or greater, or 0.05 MPa or greater, and 0.50 MPa or less, 0.30 MPa or less, or 0.20 MPa or less. When a gas stream with this injection pressure is used, transparent solid spheres having a relatively uniform shape and particle size are obtained.

The nozzle for jetting the gas stream has one or more injection holes. The hole diameter of the injection hole is, for example, 0.1 millimeters or more, 0.3 millimeters or more, or 0.5 millimeters or greater, and 2.5 millimeters or less, 2.0 millimeters or less, or 1.5 millimeters or less.

The method for producing the transparent solid spheres of some embodiments may include optional steps. For example, a step of further cooling the spheres repelled by the gas stream may be included.

The use of the transparent solid spheres of the present disclosure is not particularly limited. Because the transparent solid spheres of the present disclosure have excellent transparency and retroreflectivity, they can be used in, for example, decorative articles, abrasive materials, fillers of wear resistant coatings, and retroreflective articles. Among these, the use in retroreflective articles is preferable.

Because the transparent solid spheres of the present disclosure have excellent retroreflectivity, they can be used, for example, in various markers (e.g., signs), particularly pavement markers. In this case, the transparent solid spheres may be included, for example, in a coating composition for a pavement marker, or the transparent solid spheres may be scattered over a marker with which a pavement is coated, in an undried state, and partially buried therein.

The transparent solid spheres of the present disclosure may also be used, for example, in a pavement marking sheet (tape). In addition, the transparent solid spheres of the present disclosure may be appropriately used, for example, for a sheet including an exposed lens, an encapsulated lens, or an embedded lens.

The pavement marking sheet (tape) may include a backing layer, a binder layer, and transparent solid spheres partially embedded in the binder layer.

The backing layer is generally less than 3 millimeters thick, and may be made of various materials such as polymeric films, metal foils, or fiber-based sheets, which may be used alone or in combination. Examples of the material of the polymer film or the fiber-based sheet may include acrylonitrile butadiene polymer, polyurethane, and various rubber materials (e.g., neoprene rubber), which may be used alone or in combination. The backing layer may appropriately include, for example, various particulate materials (e.g., particulate fibers, and slip-resistant particles). As necessary, an adhesive such as a pressure sensitive adhesive, a contact pressure adhesive, or a hot melt adhesive may be optionally applied to the backing layer on the opposite side to the binder layer.

Examples of the binder material of the binder layer include vinyl polymers, polyurethanes, epoxides, and polyesters, which may be used alone or in combination. The binder material may optionally include a colorant (e.g., an inorganic pigment).

The pavement marking sheet may be produced by various known methods. For example, a mixture of a binder resin, a pigment, and a solvent is applied to the backing layer to form a binder layer. Next, the transparent solid spheres of the present disclosure are scattered over and partially embedded in the surface of the binder layer in an undried state, and the binder layer is cured as necessary, thus obtaining a pavement marking sheet. Optionally, an adhesive layer may be formed on the backing layer on the opposite side to the binder layer.

### EXAMPLES

Specific aspects of the present disclosure will be exemplified in the following examples, but the present disclosure is not limited to these aspects. All parts and percentages are based on mass, unless otherwise stated.

The materials used in the present examples are shown in Table 1.

TABLE 1

| Material brand | | |
|---|---|---|
| name or | | |
| abbreviation | Explanation | Obtained from |
| BW-E1 | Barium | Sakai Chemical Industry Co., Ltd. |
| | carbonate | (Sakai-shi, Osaka, Japan) |
| | powder | |
| CR-EL | Titanium | ISHIHARA SANGYO KAISHA, LTD. |
| | dioxide | (Nishi-ku, Osaka-shi, Japan) |
| | powder | |
| EP | Zirconium | DAIICHI KIGENSO KAGAKU |
| | dioxide | KOGYO CO., LTD. |
| | powder | (Suminoe-ku, Osaka-shi, Japan) |
| AES-12 | Aluminum | SUMITOMO CHEMICAL |
| | oxide | COMPANY, LIMITED |
| | powder | (Chuo-ku, Tokyo, Japan) |
| UB-1521M | Particle size | UNITIKA LTD. |
| | of 425 to 1180 | (Chuo-ku, Osaka-shi, Japan) |
| | micrometer | |
| | titanium | |
| | barium based | |
| | glass particles | |
| UB-108L | Particle size | UNITIKA LTD. |
| | of 106 to 850 | (Chuo-ku, Osaka-shi, Japan) |
| | micrometer | |
| | soda-lime | |
| | glass particles | |

### Example 1

In accordance with the composition ratios shown in Table 2, BW-E1 (BaCO₃), EP (ZrO₂), CR-EL (TiO₂), AES-12 (Al₂O₃) were mixed to prepare mixed materials.

TABLE 2

| | Composition on a theoretical | | | | | Retroreflectivity | |
|---|---|---|---|---|---|---|---|
| | oxide basis (%) | | | | Refractive | ((Cd/m²)/lux) | |
| | BaO | ZrO₂ | TiO₂ | Al₂O₃ | index | Dry | Wet |
| Example 1 | 39.6 | 7.3 | 48.2 | 4.9 | 2.15 | 8.0 | 3.0 |
| Example 2 | 38.4 | 6.7 | 50.1 | 4.8 | 2.15 | 6.0 | 4.0 |
| Example 3 | 45.9 | 8.5 | 39.9 | 5.7 | 2.04 | 18.0 | 3.0 |
| Example 4 | 39.4 | 9.3 | 48.0 | 3.3 | 2.15 | 9.0 | 5.0 |
| Example 5 | 39.3 | 10.6 | 47.9 | 2.2 | 2.16 | 8.0 | 5.0 |
| Example 6 | 37.5 | 9.8 | 45.6 | 7.1 | 2.11 | 7.0 | 5.0 |
| Example 7 | 38.0 | 9.9 | 46.3 | 5.8 | 2.11 | 8.0 | 4.0 |
| Example 8 | 41.0 | 3.9 | 50.0 | 5.1 | 2.14 | 6.0 | 4.0 |
| Example 9 | 37.7 | 7.0 | 45.9 | 9.4 | 2.16 | 5.0 | 4.0 |
| Example 10 | 43.2 | 5.8 | 46.7 | 4.2 | 2.12 | 6.0 | 4.0 |
| Example 11 | 36.9 | 8.7 | 51.3 | 3.1 | 2.16 | 5.0 | 5.0 |
| Example 12 | 43.3 | 4.1 | 52.7 | — | 2.18 | 9.0 | 5.0 |
| Comparative | 42.7 | — | 52.0 | 5.3 | Unmeasurable | Unmeasurable | Unmeasurable |
| Example A | | | | | | | |
| Comparative | 31.9 | 5.6 | 55.6 | 6.9 | Unmeasurable | Unmeasurable | Unmeasurable |
| Example B | | | | | | | |
| Comparative | 45.1 | — | 54.9 | — | Unmeasurable | Unmeasurable | Unmeasurable |
| Example C | | | | | | | |
| Comparative | 42.6 | 1.9 | 55.6 | — | Unmeasurable | Unmeasurable | Unmeasurable |
| Example D | | | | | | | |
| Comparative | 48.8 | 9.0 | 36.1 | 6.1 | Unmeasurable | Unmeasurable | Unmeasurable |
| Example E | | | | | | | |
| Comparative | 35.2 | 13.1 | 42.9 | 8.8 | Unmeasurable | Unmeasurable | Unmeasurable |
| Example F | | | | | | | |
| Comparative | 47.9 | 4.2 | 47.9 | — | Unmeasurable | Unmeasurable | Unmeasurable |
| Example G | | | | | | | |
| Comparative | 36.9 | 13.6 | 44.9 | 4.6 | Unmeasurable | Unmeasurable | Unmeasurable |
| Example H | | | | | | | |
| Comparative | 39.3 | 11.9 | 47.8 | 1.1 | Unmeasurable | Unmeasurable | Unmeasurable |
| Example I | | | | | | | |
| Comparative | 36.9 | 13.7 | 44.9 | 4.6 | Unmeasurable | Unmeasurable | Unmeasurable |
| Example J | | | | | | | |

| | | | | |
|---|---|---|---|---|
| Comparative | UB-1521M | 1.90 | 16.0 | 1.0 |
| Example K | | | | |
| Comparative | UB-108L | 1.50 | 5.0 | 1.0 |
| Example L | | | | |

Here, for BW-E1, the blending amount of BW-E1 (BaCO₃) is adjusted and mixed so that the composition of the barium oxide (BaO) of the transparent solid spheres has the ratio shown in Table 2 on a theoretical oxide basis. For example, in Example 1 shown in Table 2, the composition ratios of BaO, ZrO₂, TiO₂, and Al₂O₃ are 39.6%, 7.3%, 48.2%, and 4.9% on a theoretical oxide basis, so that the mixed material of Example 1 includes 51.0 g of BW-E1 (BaCO₃) (=39.6×197 (molecular weight of BaCO₃)/153 (molecular weight of BaO), 7.3 g of ZrO₂, 48.2 g of TiO₂, and 4.9 g of Al₂O₃.

A platinum crucible having an outlet hole with a diameter of approximately 2 millimeters at one point on the bottom was prepared, and the crucible was filled with the prepared mixed material. The crucible was set in an oven and gradually heated to about 1450° C. at a temperature raising rate of about 18.75° C./minute, thereby melting the mixed material to obtain a melt. A nozzle for jetting a gas stream was placed near the point about 75 cm away from the outlet hole of the crucible so as to be substantially perpendicular to the discharge stream of the melt. The injection nozzle had 16 injection holes with a diameter of approximately 1 millimeter.

The outlet hole of the crucible was opened and the discharge stream of the melt was discharged through it, and a gas stream (air jet stream) with an injection pressure of about 0.125 MPa was injected from the injection nozzle. The melted drops repelled by the gas stream were cooled in the air to form transparent solid spheres. The transparent solid spheres were measured using a sieve with an opening of 600 to 850 micrometers, and as a result, it was confirmed that transparent solid spheres with a particle size of 600 micrometers or more had been obtained.

### Examples 2 to 12 and Comparative Examples A to J

Solid spheres of Examples 2 to 12 and Comparative Examples A to J were prepared in the same manner as in Example 1 in accordance with the composition ratios shown in Table 2, except that BW-E1 (BaCO₃), EP (ZrO₂), CR-EL (TiO₂), AES-12 (Al₂O₃) were mixed to prepare a mixed material. All the solid spheres had a particle size of 600 micrometers or more.

### Comparative Example K

Commercially available retroreflective glass beads (UB-1521M) were used.

### Comparative Example L

Commercially available retroreflective glass beads (UB-108L) were used.

### Physical Property Evaluation Test

The properties of the obtained solid spheres and commercially available retroreflective glass beads were evaluated using the following method.

### Refractive Index

The refractive index of solid spheres or glass beads was measured based on “Refractive Index Measurement of High Refractive Index Beads” T. Yamaguchi, Applied Optics, vol. 14, No. 5, p. 1111-1115 (1975). The disclosure of these documents is incorporated herein by reference. The results are shown in Table 2 above. However, because the solid spheres in Comparative Examples A to J were cloudy, their refractive index could not be measured.

### Retroreflectivity Test

Solid spheres or glass beads were obtained using a sieve with an opening of 600 to 850 micrometers. The retroreflectivity of the obtained solid or glass beads in a dry state and a wet state was measured using a retroluminometer (“Retroreflectmeter Retrosigh DK-2970 Horshlm Type GR-3”, manufactured by DeltaLight & Optics). A white plate having cavities with a depth of 1 millimeter is prepared, and solid spheres or glass beads are placed in the cavities to form a planar single layer of solid spheres or glass beads with a thickness of 1 millimeter. White light is emitted from the retroluminometer at a predetermined inlet angle to the normal perpendicular to the single layer. The retroreflectivity is determined in the unit of (Cd/m²)/lux by the photodetector of the retroluminometer, measuring the white light that was emitted at the inlet angle of −4° and reflected at the divergence angle (observation angle) of 0.2°. The results are shown in Table 2 above. However, because the solid spheres in Comparative Example A ˜ J were cloudy, it was not possible to measure the retroreflectivity.

### Results

As indicated by the results in Table 2 above, in Examples 1 to 12, transparent solid spheres exhibiting a refractive index of at least 2.00 and having a particle size of at least 600 micrometers were obtained.

The commercially available transparent glass beads in Comparative Examples K and L had a low refractive index of less than 2.00, indicating that they have excellent retroreflectivity in a dry state, but their retroreflectivity in a wet state was not sufficient. On the other hand, the transparent solid spheres of Examples 1 to 12 were found to have excellent retroreflectivity both in a dry state and in a wet state.

It will be apparent to those skilled in the art that various modifications can be made to the aspects and examples described above without departing from the basic principles of the present invention. It will also be apparent to those skilled in the art that various improvements and modifications of the present disclosure can be made without departing from the gist and scope of the present disclosure.

1. (canceled)

2. The method according to claim 13, wherein the weight ratio of the barium oxide is from 35 to 47% on a theoretical oxide basis relative to the total weight of the transparent solid spheres, and the weight ratio of the zirconium dioxide is from 2 to 11.5% on a theoretical oxide basis relative to the total weight of the transparent solid spheres.

3. The method according to claim 2, wherein the weight ratio of the titanium dioxide is from 37 to 54% on a theoretical oxide basis relative to the total weight of the transparent solid spheres.

4. The method according to claim 13, wherein the transparent solid spheres further comprise aluminum oxide.

5. The method according to claim 4, wherein the weight ratio of the aluminum oxide is from 1.5 to 11% on a theoretical oxide basis relative to the total weight of the transparent solid spheres.

6. The method according to claim 13, wherein the particle size of the transparent solid spheres is 850 micrometers or greater.

7. The method according to claim 13, wherein the particle size of the transparent solid spheres is 1 millimeter or greater.

8. The method according to claim 13, wherein the refractive index of the transparent solid spheres is 2.1 or greater.

9. The method according to claim 13, wherein the transparent solid spheres have a crushing strength of 150 MPa or greater.

10. The method according to claim 13, wherein the weight ratio of silicon dioxide is 5% or less on a theoretical oxide basis relative to the total weight of the transparent solid spheres.

11. (canceled)

12. (canceled)

13. A method for producing transparent solid spheres comprising barium oxide, zirconium dioxide, and titanium dioxide on a theoretical oxide basis, having a refractive index of at least 2.0 and a particle size of 600 micrometers or greater, the method comprising the steps of:
preparing a melt comprising (a) at least one of barium oxide and barium carbonate, (b) zirconium dioxide, (c) titanium dioxide, and optionally aluminum oxide;
releasing a discharge stream of at least a portion of the melt through a hole, and injecting a gas stream to the discharge stream to obtain spheres; and
cooling the spheres to form transparent solid spheres.
